(19) United States
(12) Patent Application Publication
(10) Pub. No.: US 2010/0094759 A1
(43) Pub. Date: Apr. 15, 2010

(54) Mobile Commerce Enablement Systems and Methods

(76) Inventors: Basil Kanno, West Chester, OH (US); Pablo Godel, Miami, FL (US)

Correspondence Address: DINSMORE & SHOHL LLP, 1900 CHEMED CENTER, 255 EAST FIFTH STREET, CINCINNATI, OH, 45202, US

(21) Appl. No.: 12/578,311

(22) Filed: Oct. 13, 2009

Related U.S. Application Data
(60) Provisional application No. 61/104,529, filed on Oct. 10, 2008.
(60) Provisional application No. 61/119,924, filed on Dec. 4, 2008.

(51) Int. Cl. G06Q 30/00; H04L 12/58; H04M 3/42; H04W 4/12; H04L 9/00; G06Q 10/00; G06F 3/048

(52) U.S. Cl. 705/50; 455/412.1; 455/414.1; 455/466; 705/8; 705/14.16; 705/14.25; 705/14.44; 705/14.45; 705/14.52; 705/14.56; 705/14.64; 715/764

(57) ABSTRACT

Mobile commerce systems and methods are provided. In one embodiment, a mobile commerce platform includes a visual design tool. The mobile commerce platform may be electronically stored on a computing device, such that it is configured to manipulate computer readable data electronically stored on the computing device. The visual design tool may include an interactive graphical canvas and a block diagram. The interactive graphical canvas may be configured to enable the modification of the block diagram. The block diagram may include a first object block, a second object block and at least one connecting symbol. The first object block may define a first campaign instance, the second object block may define a second campaign instance, and the at least one connecting symbol may define a campaign sequence. Further, the mobile commerce platform may be configured to execute a mobile campaign according to the first campaign instance, the second campaign instance, and the campaign sequence.

### CROSS-REFERENCE TO RELATED APPLICATIONS

This application claims priority to provisional patent application No. 61/104,529 filed on Oct. 10, 2008 and provisional patent application No. 61/119,924 filed on Dec. 4, 2008, both of which are incorporated herein by reference in their entirety.

### TECHNICAL FIELD

Embodiments of the present disclosure generally relate to automated systems and methods for creating and managing an informational campaign and, more specifically, automated systems and methods for controlling the flow of information and promotional coupons to mobile devices.

### BACKGROUND

Mobile devices are nearly ubiquitous in much of the world. In response to the vast usage of mobile devices, marketing campaigns commonly use the mobile device as a channel to reach consumers. For instance, a retailer may seek to increase foot traffic in its store by sending coupons to mobile devices via a SMS. Such a mobile couponing campaign can be created utilizing a traditional couponing service. However, such services often offer only simple one way communication or limited options regarding the structure of a mobile couponing campaign.

Furthermore, the use of text messaging for the exchange of information between a mobile campaign and the consumer creates an environment where rapid responses are common. However, in a traditional system the information exchange is typically one sided with little feedback. Therefore, a great deal of information is lost, as well as valuable insight into consumer transactions. At present, a marketer is left with two undesirable choices: utilizing a service to manage a mobile marketing campaign with little or no feedback, or developing a complex system specific to the desired campaign.

Accordingly, alternative mobile commerce systems and methods for controlling the flow of information and promotional coupons to mobile devices are desired.

### SUMMARY

In one embodiment, a mobile commerce platform includes a visual design tool. The mobile commerce platform may be electronically stored on a computing device, such that it is configured to manipulate computer readable data electronically stored on the computing device. The visual design tool may include an interactive graphical canvas and a block diagram. Where the interactive graphical canvas may be configured to enable the modification of the block diagram. The block diagram may include a first object block, a second object block and at least one connecting symbol. The first object block may define a first campaign instance, the second object block may define a second campaign instance, and the at least one connecting symbol may define a campaign sequence. Further, the mobile commerce platform may be configured to execute a mobile campaign according to the first campaign instance, the second campaign instance and the campaign sequence.

In another embodiment, a method for creating and managing an information flow of a mobile campaign includes registering at least one subscriber mobile device into a mobile commerce platform. The mobile commerce platform may be electronically stored on a computing device and may be configured to manipulate computer readable data electronically stored on the computing device. The method further includes providing an interactive graphical canvas. The interactive graphical canvas may be configured to invoke at least one operation of the mobile commerce platform. An additional portion of the method includes providing a block diagram within the interactive graphical canvas. The block diagram may be configured to be altered and may include a first object block, a second object block and at least one connecting symbol. The method still further includes executing, in a sequence determined by the at least one connecting symbol, the at least one operation according to the first object block and the at least one operation according to the second object block.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 depicts a schematic illustration of a mobile commerce system according to one or more embodiments illustrated and described herein;

FIG. 2 depicts a schematic illustration of a visual design tool according to one or more embodiments illustrated and described herein;

FIG. 3 depicts a flow chart illustration of a mobile commerce system according to one or more embodiments illustrated and described herein;

FIG. 4A depicts a schematic illustration of a category property according to one or more embodiments illustrated and described herein;

FIG. 4B depicts a schematic illustration of a subscriber group property according to one or more embodiments illustrated and described herein; and

FIG. 4C depicts a schematic illustration of an attribute property according to one or more embodiments illustrated and described herein.

### DETAILED DESCRIPTION

Embodiments of the present disclosure generally relate to systems and methods for increasing the efficiency and responsiveness of a mobile campaign. Such results are achieved by providing a mobile commerce platform in which a client may design a mobile campaign that wirelessly transmits information to targeted mobile devices, such as, but not limited to mobile phones, GPS devices, PDA's, Handheld PC's, and portable media players, via, for example, MMS, SMS or email formats. More specifically, embodiments may comprise a mobile commerce platform which may comprise a visual design tool.

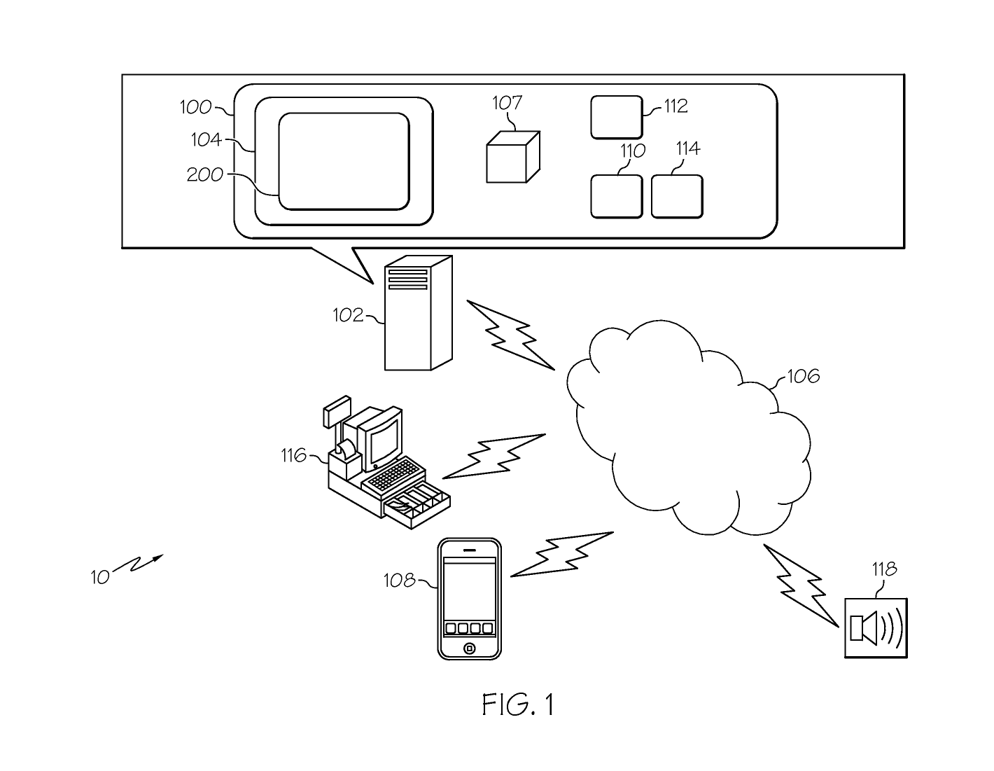

An embodiment of a mobile commerce system 10 is shown in FIG. 1. The mobile commerce platform 100 may be electronically stored on a computing device 102 and may be configured to manipulate computer readable data electronically stored on the computing device. The term “computing device” 102 means any device capable of executing instructions that are electronically stored in a tangible medium. A computing device 102 may be a server, a desktop, or a mobile device, for example.

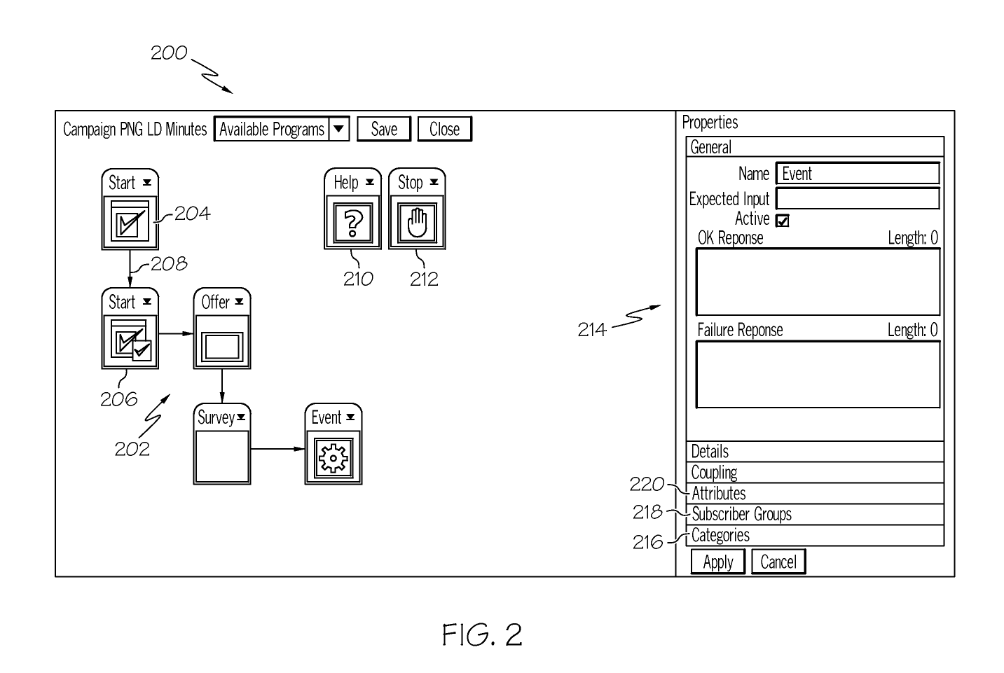

Referring now to FIG. 1 and FIG. 2, an embodiment of the mobile commerce platform 100 comprises a visual design tool 104. The visual design tool 104 comprises an interactive graphical canvas 200 and a block diagram 202. The interactive graphical canvas 200 is configured to enable the modification of the block diagram 202. The block diagram 202 comprises a first object block 204, a second object block 206, and at least one connecting symbol 208.

The first object block 204 defines a first campaign instance, the second object block 206 defines a second campaign instance, and the at least one connecting symbol 208 defines a campaign sequence. The phrase “instance,” as used herein, means the actual object executed by the mobile commerce platform at runtime. For example, an object block can be created within the interactive graphical canvas. The object block may contain a number of fields that are configured to be modified. The instance relating to the object block is an action taken by the mobile commerce engine that corresponds to the fields of the object block. Additionally, the at least one connecting symbol 208 can define the order of actions taken by mobile commerce engine at run time. For example, the at least one connecting symbol 208 may be a connecting arrow, and the order can be defined by the direction the connecting arrow is pointing. In the case where the connecting arrow starts at a first object block 204 and terminates at a second object block 206, the first campaign instance would occur first, while the second campaign instance would occur second. As such, the mobile commerce platform 100 can be configured to execute a mobile campaign according to the first campaign instance, the second campaign instance, and the campaign sequence. Such a workflow based architecture offers a template-based campaign definition that is fully customizable. Further features may include multi-campaign per short code support and multi-keyword per campaign support.

The mobile commerce platform 100 can exchange electronic information via all mobile communication protocols, which includes, but is not limited to, SMS, MMS, WAP push and email. Furthermore, the mobile commerce platform 100 may comprise an extensible architecture which may enable it to support new communication protocols and applications. Therefore a mobile campaign may comprise one or more of sending and receiving data through a wireless network 106. The term “wireless network” means, for example, satellite, Wi-Fi networks, Wi-Max networks, Fixed/Mobile Convergence devices, and traditional cellular networks, typically comprising a radio network made up of a number of radio cells, as well as any other means of communicating electronic information to and from a mobile device.

Examples of supported mobile campaigns comprise text for information, and alerts. Thus the mobile commerce platform 100 may be configured to receive a text and in response transmit information, such as weather, traffic, or sports. In order to receive a traffic update, for example, a subscriber may text “I75” to the mobile commerce platform 100 via a short code, a z code, or any other suitable transmission and receive traffic conditions on an interstate. Additionally, the mobile commerce platform 100 may be configured to transmit alerts, such as college or business campus emergencies. For instance, a university could send a message to all of its students alerting them that classes are canceled due to a flu outbreak.

Another example of a mobile campaign arises in a retail scenario. The mobile commerce platform 100 may be configured to send coupons to mobile devices via, MMS, SMS, or email messaging, for example. The coupons may comprise, one or more of, alphanumeric code, graphics, text describing the promotion, linear barcode, two-dimensional barcode, and a link to a web site. The mobile commerce platform 100 may be configured to direct a mobile campaign in any campaign sequence as directed by the block diagram 202.

In embodiments of the mobile commerce platform 100, one or more of the first object block 204 and the second object block 206 may comprise a property set 214. The property set 214 can be configured to be accessed by a mouse click. Additionally, the mobile commerce platform 100 may include a behavioral engine 108, where the behavioral engine 108 is configured to access the property set and invoke a filter operation. The filter operation acts to, for example, target coupon deliveries to consumers likely to redeem the coupons. The behavioral engine 108 considers various data associated with the property set based on subscriber interaction with a mobile campaign. The behavioral engine 108 may calculate various statistics and rank them for each subscriber, and is thus configured to analyze coupon redemption data, to predict future recipient behavior and subsequently modify future campaigns to further increase efficiency and redemption

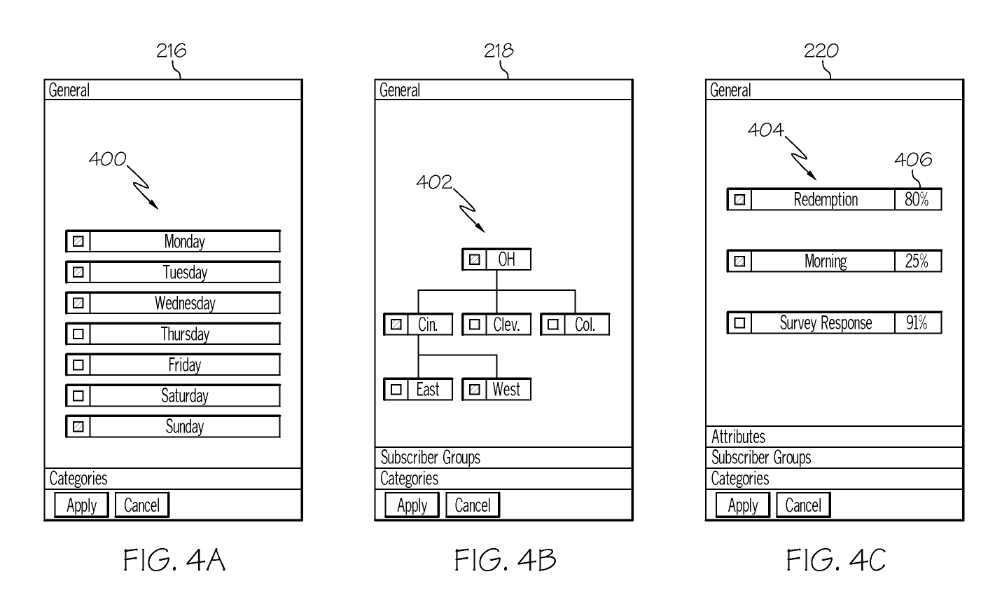

Referring to FIG. 2, the property set 214 may comprise one or more of a category property 216, subscriber group property 218 and an attribute property 220. The category property 216, as shown in FIG. 4A, may comprise multiple desired event fields 400. Subscribers may be associated with each of the desired event fields 400. The category property may be configured to be accessed to set a selected group of the desired event fields 400. The filter operation may comprise eliminating subscribers from a campaign instance based on the subscribers associated with the selected group. The mobile commerce platform 100 may be configured to associate subscribers with a default set of the desired event fields. The default set may include, for example, minimum and maximum number of messages that the subscriber is willing to receive per day, the days in the week the subscriber is willing to receive messages and the time range in a day that the subscriber is willing to receive messages. The default set of the desired event fields may be modified during the opt-in process or at any time, via the subscriber portal. The mobile commerce platform 100 may be configured to be accessed through the subscriber portal via an electronic communication means, such as, but not limited to a website. Furthermore, the default set of the desired event fields may be modified at any time via the mobile device, by, for example, an SMS message containing a specified keyword. It should further be understood that the category property 216 may be configured to comprise the desired event fields 400 arranged in a hierarchy.

In another embodiment, illustrated in FIG. 4B, the subscriber group property 218 may comprise multiple segments 402. The multiple segments may be hierarchical with subscribers associated with each of the segments 402. The subscriber group property 218 may be configured to be accessed to set a selected group of the multiple segments 402. The filter operation may comprise eliminating subscribers from a campaign instance based on the subscribers associated with the selected group. Through the use of the subscriber group property, subscribers may be segmented into any number of groups. Groups can reflect any desired dimension, such as, region, store location, and demographic property. Thus a mobile campaign can be targeted to achieve a better subscriber response.

Additional filter examples include use of the attribute property 220, which may comprise multiple interaction fields 404. The interaction fields 404 may comprise a tracking statistic 406 and subscribers can be associated with each of the interaction fields 404 and the tracking statistic 406. The tracking statistic 406 can be based on a subscriber's interaction with the mobile campaign. The attribute property 220 may be configured to be accessed to set a selected group of the interaction fields 404. The filter operation may comprise eliminating subscribers from a campaign instance based on the tracking statistic associated with the selected group. Thus the behavioral engine can perform filter operations associated with each subscribers' attributes or behavioral tendencies. Examples of such attributes are rate of coupon redemption, time of coupon redemption, and responsiveness to surveys. However, it should be understood that, the types of attributes are unlimited as they are based on the mobile campaign, which can be developed based on an unlimited number of block diagram 202 configurations. Furthermore, the attribute property 220 may comprise the interaction fields 404 arranged in a hierarchy.

Other embodiments of the mobile commerce platform 100 may comprise a first object block 204 and a second object block 206, wherein one or more of the first object block and the second object block can be a start object, a join object, offer object, a survey object, or an event object. The start object corresponds to a mobile commerce platform 100 action for executing a double opt-in to confirm participation in a corresponding event. The join object corresponds to a mobile commerce platform 100 action denoting that the subscriber has elected to participate in a corresponding event. The offer object corresponds to a mobile commerce platform 100 action for transmitting a message to a mobile device 108, including, for example, a coupon or an alert. The survey object corresponds to a mobile commerce platform 100 action for transmitting a message to a mobile device 108 and storing the response. The event object corresponds to a mobile commerce platform 100 action for transmitting information to a mobile device 108. Such a transmission may comprise, an alert, promotional text, or text for information, for example.

For the purpose of describing and defining the present disclosure, the term “subscriber” denotes an identification associated with a mobile device 108 for which the mobile commerce platform 100 has both the permission and capability of communicating with electronically. Furthermore, the phrase “opt-in” relates to the process to which a subscriber subscribes to a mobile campaign and the phrase “double opt-in” relates to an opt-in where the mobile commerce platform 100 verifies that the request to subscribe was sent by the subscriber. For example, a subscriber may opt-in to the mobile campaign by sending an SMS that corresponds to a billboard advertisement to the mobile commerce platform 100. While, in a double opt-in embodiment, the mobile commerce platform 100 would not register the subscriber until it receives a further confirmation. The mobile commerce platform 100 may be configured to subscribe subscribers through any communication means, such as through a wireless network or through the subscriber portal. Furthermore, the mobile commerce platform 100 may be configured to subscribe subscribers via pre-qualified lists. In the case of cell phones, the mobile commerce platform 100 may be configured to import and export pre-qualified lists of mobile numbers, which correspond to mobile numbers that have successfully opted-in. The pre-qualified list may be in any format, such as CSV, xml or fixed width, and may comprise information, such as mobile number, opt-in date and name. Additionally, the mobile commerce platform 100 may be configured to ignore any records in the pre-qualified list that contain invalid information.

The mobile commerce platform is configured to adhere to all applicable Mobile Marketing Association (MMA) consumer best practices guidelines. As such, the interactive graphical canvas 200 may comprise one or more of a help object 210 and a stop object 212. The help object 210 corresponds to a mobile commerce platform 100 action for transmitting help information to a mobile device. The stop object 212 corresponds to a mobile commerce platform 100 action for opting-out a subscriber mobile device. For example, a subscriber may opt-in by sending a specified alias to the mobile commerce platform 100 via SMS, the mobile device 108 that sent the alias will no longer participate in the mobile campaign. Examples of mandatory stop aliases, as defined by the MMA, are end, cancel, unsubscribe and quit.

The mobile commerce platform 100 may further comprise an action mapping tool. The action mapping tool enables the creation aliases for a predefined mobile commerce platform 100 action and combinations of actions. For example, an alias such as “FREE” may be mapped to a block diagram 202 comprising the actions of sending a coupon to the subscriber for a free coffee and a subsequent text message delayed for two hours asking the subscriber if the coffee was enjoyable. Thus, a SMS from the subscriber including the alias “FREE” would cause the mobile commerce platform 100 to take the actions mapped to the alias.

In further embodiments of the mobile commerce platform 100, one or more of the first object block 204 and the second object block 206 may comprise a pattern scheduler, a trigger scheduler, and a range scheduler. The pattern scheduler may be configured to invoke a recurrence pattern operation for the transmission of a message through the wireless network 106 in a repeating interval of time. The message may be any type of message, for example, a coupon, a promotion, or information and the repeating interval of time may be any time, such as, daily, weekdays, weekly, monthly or annually. For example, if the repeating interval were set for weekdays for a coffee coupon, a subscriber would receive a coupon for coffee every weekday. The trigger scheduler may be configured to invoke a trigger operation for the transmission of the message through the wireless network 106 at a set time or upon the occurrence of a pre-defined event. For example, the pre-defined event may be the redemption of a coupon for a free breakfast. Upon such a redemption, the trigger operation may be the transmission of a informational message describing the health benefits of the breakfast. The range scheduler may be configured to invoke a range operation for the transmission of the message through the wireless network 106 throughout a time period. The mobile commerce platform 100 may thus be configured to transmit messages for a specific range of time. For instance, the weekday coffee coupon may be set for transmission for one month coinciding with the introduction of a new flavor of coffee with the range scheduler. In another example, a campaign may comprise transmitting coupons for an ice cream parlor near a high school to students right after school is dismissed. Such targeted promotional coupons are likely to have a higher redemption rate, than a non-targeted campaign.

Further embodiments of the mobile commerce platform 100 described herein may comprise a graphics tool 110 and a coupon code generator 112 as illustrated in FIG. 1. The graphics tool 110 may be configured to import graphics and promotional text to generate a coupon design. The coupon code generator 112 may be configured to generate a coupon code. The coupon code may be any code, such as, an alphanumeric code, a linear barcode, or a two-dimensional barcode, for example. The mobile commerce platform 100 may be configured to generate a coupon message comprising the coupon design and the coupon code. The coupon message may be configured to be displayed on a mobile device 108.

In another embodiment, the mobile commerce platform may be configured to receive a photo message through a wireless network 106. The photo message may be transmitted via MMS or email and may comprise a photograph of a barcode. The barcode may be a one dimensional barcode or a two dimensional barcode. The mobile commerce platform 100 may further comprise a barcode validator 114, such that the barcode validator 114 is configured to extract the barcode from the photo message and convert the barcode into a decoded data. The decoded data may be electronically stored on the computing device 102. The mobile commerce platform 100 may be configured to transmit a decoded message to the mobile device 108 through the wireless network 106. The decoded message may comprise a URL that links to the decoded data. For example, if a two-dimensional barcode corresponded to a word, the word would be displayed as decoded data on a website.

Additional examples of the mobile commerce platform 100 described herein may comprise a set of web services interface and application programming interfaces (APIs) to external systems for various communications purposes, such as, for example, determining the validity of a coupon or promotion. Additional capabilities of the mobile commerce platform 100, accessible by the set of web services and APIs include, but are not limited to, messaging, pin generation, barcode generation, barcode validation, encryption/decryption, OCR capabilities, billing/invoicing, reporting and analytics. For the purposes of defining and describing the present disclosure, “OCR” means converting graphic representations of alphanumeric codes to computer readable text via software.

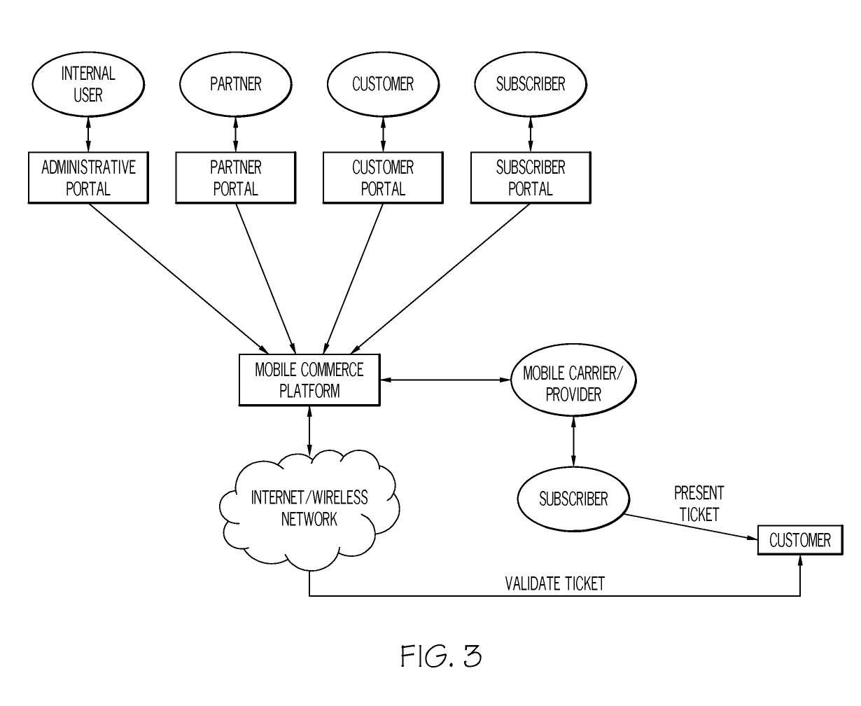

Further means to access the functionality of the mobile commerce platform 100 may comprise portals. Portals may be configured to define various access privileges to a set of users. For example, a first user may have access limited to the mobile commerce engine 100 functionality but not the account information, while a second user may have full access. As shown in FIG. 3, various portals may be provided for, such as an administrative portal, a partner portal, a customer portal, and a subscriber portal. Each portal may be configured for different classes of users. For example, in a joint campaign designed by an administrator where a customer is a shoe store and a partner is a sock store, each user may require differing access to the functionality of the mobile commerce platform.

For example, the administrative portal may serve as the entry point for access all of the functionality of the mobile commerce platform 100, partner information and customer information. The functionality of the administrative portal includes, but is not necessarily limited to, access privilege definitions, carrier configuration, aggregator configuration, short code configuration. Access privilege definitions may be defined at the module, page and action levels for each internal user and group of users. Thus access privilege may be modified to vary the functionality and information that can be viewed through a particular portal. As such, the administrative portal can be used to create any number of portals with any amount of access, in order to tailor a campaign to a particular business circumstance. The portals, in the joint campaign example, may be configured such that the partner portal is partitioned with the capability to only view information relating to sock store customers and the customer portal is partitioned with the capability to only view information relating to shoe store customers.

The carrier configuration tool may be accessed through a portal to create, edit or delete mobile carriers. The aggregator configuration tool may be accessed through a portal to create, edit, or delete mobile aggregators. The mobile commerce platform 100 may interface with a mobile carrier to send and receive mobile messages, where the mobile carrier fulfills the delivery and reception of these messages between the mobile commerce platform 100 and the mobile device 108. The short code configuration tool may be accessed through a portal to create, edit, or delete mobile short codes. Thus, continuing the joint campaign example, the administrative portal could set the campaign to accept text messages from a certain cellular service and modify the types of short codes accepted by the joint campaign. Additionally, a portal may provide access to various other features, such as, but not limited to, monitoring message transactions for active and completed events, event statistics, and reporting.

Still referring to FIG. 1, additional communication means relate to further embodiments of the mobile commerce platform 100. The mobile commerce platform 100 may be configured to transmit and receive communications from a host 116. A host 116 is any device that accesses the capabilities of the mobile commerce engine, such as, for example, an imager, a scanner, a PC, or a POS system. The host 116 may be configured to access the services of the mobile commerce platform 100 via, for example, APIs. Once configured the host may communicate with the mobile commerce platform 100 through the use of any type of connection, for example, wired internet, wireless internet, or a wireless network 106. In a typical coupon redemption transaction, a retail customer may show a coupon code displayed on a mobile device 108 to a retailer. The retailer then may scan the coupon code, which may comprise, any of a barcode or alphanumeric code from the device's screen using any type of host 116. The host 116 then communicates the electronic coupon code information to the mobile commerce platform 100 which then validates the coupon code.

Furthermore, information relating to the time of the transaction, type of promotion or the fact that the coupon has been redeemed, may be associated with the subscriber mobile device 108 and stored within the mobile commerce platform 100. Other information may also be associated with the subscriber mobile device 108 and stored within the mobile commerce platform 100. Thereafter, the information is accessible for use throughout the mobile commerce platform 100, such as for analysis of the redemption data with respect to different variables or filter operations of the behavioral engine 108.

In some embodiments of the present disclosure, the mobile commerce platform 100 may be configured to receive a coupon code, which may be an SMS, from a designated mobile device through the wireless network 106. The mobile commerce platform 100 may be further configured to validate the coupon code and transmit the validation to the designated mobile device through the wireless network 106. Such a redemption method extends the functionality of the mobile commerce platform 100 to a relatively inexpensive device. The powerful functionality of the mobile commerce platform 100 can then be leveraged to establish a sophisticated redemption system in even a remote location by receiving and processing coupon codes and returning the results to the designated mobile device.

Referring to both FIGS. 1 and 2, aspects of the present disclosure relate to methods for creating and managing the information flow of a mobile campaign. The methods may include registering at least one subscriber mobile device 108 into a mobile commerce platform 100. The mobile commerce platform 100 may be electronically stored on a computing device 102 and may be configured to manipulate computer readable data electronically stored on the computing device 102. The methods may further include providing an interactive graphical canvas 200. The interactive graphical canvas 200 may be configured to invoke at least one operation of the mobile commerce platform 100. The methods may additionally comprise providing a block diagram 202 within the interactive graphical canvas 200. The block diagram 202 may be configured to be altered and may comprise a first object block 204, a second object block 206 and at least one connecting symbol 208. The methods may also include executing, in a sequence determined by the at least one connecting symbol 208, the at least one operation according to the first object block 204 and the at least one operation according to the second object block 206.

Further, embodiments of the present disclosure relate to methods comprising segmenting the at least one subscriber mobile device 108 into at least one subscriber group. The methods may include associating actions of the at least one subscriber mobile device 108 with at least one attribute. Additionally, the methods may include storing electronically at least one preference of the at least one subscriber mobile device 108. The methods may further include categorizing the at least one subscriber mobile device 108 based on the at least one preference into at least one category. The methods may still further include measuring a statistic based on one or more of the at least one subscriber group, the at least one behavioral tendency, and the at least one category, and invoking at least one operation based on the statistic.

Embodiments may also safeguard sensitive data through the use of an interactive voice response (IVR) system 118. Such embodiments allow a subscriber to verify a transaction without having to transmit sensitive data, like passwords, through a text message. An example of such an embodiment includes transmitting an electronic signal that corresponds to a transaction that requires verification from the mobile commerce platform 100 to an IVR system 118. The method further includes calling the at least one subscriber mobile device 108 and collecting a PIN from the at least one subscriber mobile device 108 with the IVR system 118. The PIN may be any combination of characters that can be collected by an IVR system, for example verbal or key pad. Additionally, embodiments include communicating electronically the PIN to the mobile commerce system 100. Then verifying that the PIN matches an associated PIN. The associated PIN may be associated with the at least one subscriber mobile device 108 and may be electronically stored on a computing device 102. The method may also include creating a result that is affirmative or negative. Affirmative corresponds to a match between the PIN and the associated PIN, and negative corresponds to a mismatch between the PIN and the associated PIN. Embodiments may also include communicating the result to the at least one subscriber mobile device 108. The mobile commerce system 100 may also be configured to direct a phone call from IVR system 118 to any other number.

Some embodiments enable viral marketing. Such marketing is achieved when subscribers refer other subscribers to a mobile campaign. Referrals can be encouraged by rewarding referring subscribers with, for example, a special offer. This “tell-a-friend” feature tracks all opted-in subscribers and those who referred them. New subscribers may notify the mobile commerce platform as to who referred them by various mediums, such as a cell phone, online, or call-in. The notification methods may vary from medium to medium. For example, a method may include establishing a referral quota, and tracking a referral metric associated with the at least one subscriber mobile device 108. The referral metric may be based on the number of opt-in notifications associated with the at least one subscriber mobile device 108. The method may also include rewarding an account associated with the at least one subscriber mobile device 108 when the referral metric meets the referral quota. The quota may be of unlimited duration or for a set period of time.

Additional embodiments may also relate to a system that organizes a subscriber's transactions with the mobile commerce platform 100. An application may reside on a mobile device 108 and may be used to manage and organize transactions. Alternatively, the application may reside on a web site that is configured to be accessed by, for example, using a browser on the mobile device 108. Transactions may include, among other things: gift cards, identification cards (passport, driver license, etc), credit cards, bank cards, ATM cards, debit cards, coupons, boarding pass, loyalty program cards, and retail credit cards. All sensitive information related to a transaction may be encrypted using strong encryption algorithms, like 256-bit AES encryption. The encrypted information may then be represented by a barcode for scanning purposes. The encrypted information may then be communicated to the mobile commerce platform 100 for encryption or decryption. These transactions can be managed using over the air technology. For example, if a mobile device 108 is lost, a call center representative could erase all the transactions on the mobile device. Such a method may include organizing a transaction data associated with the at least one subscriber mobile device 108 and then transmitting an encrypted portion of the transaction data through the wireless network 106. The method may further include converting the encrypted portion to decrypted information that is configured to be displayed on the at least one subscriber mobile device 108. The decrypted information may be in a barcode or alphanumeric format. The method may further include erasing the decrypted information upon loss of the at least one subscriber mobile device 108.

Further embodiments disclosed herein relate to various mobile applications, such as couponing, ordering, ticketing, shopping, and polling. The mobile couponing application could enable direct interaction with mobile devices for marketing and advertising purposes. The mobile ticketing application could enable the transmission of tickets directly to a mobile device. The mobile commerce platform 100 may interface with a mobile carrier to send and receive mobile tickets, for example via SMS or MMS. The mobile carrier could fulfill the delivery and reception of tickets between the mobile commerce platform and subscribers. Ticket information may be encrypted using strong encryption algorithms and may be encoded with a barcode. The tickets may then be presented to a host for scanning. The ticket may then be sent to the mobile commerce platform through the use of any type of connection, such as wired internet, wireless internet, or wireless network 106.

The shopping application may utilize a shopping cart that searches a partner site for keywords entered through the mobile device, via for example SMS. Further functionality may include displaying details of items, adding a quantity of items to the shopping cart, listing the contents of the shopping cart, paging forwards and backwards in the list and clearing the contents of the cart. A checkout method may send the order as an email to an email address associated with the mobile device 108. Additionally, a secured shopping cart may be configured such that purchases must be verified utilizing the IVR system 118. For example, after attempting to purchase an item through a secured shopping cart, the mobile device 108 may be called by the IVR system. If the PIN is entered correctly the transaction could then be processed. Alternatively, if the required PIN is not entered, the IVR system could then route the call to a call center for verification.

Still further embodiments disclosed herein relate to applications which may reside on mobile devices used for navigation, commonly called GPS systems. For example, many GPS systems are stand alone units or comprise a mobile device 108 with navigation software. The mobile commerce platform 100 may be configured to interact with such a GPS system by, for example, executing an action associated with an icon displayed on the GPS system. The action could be used as a technique for businesses to attract subscribers. For example the GPS system could detect and display a brand corresponding to a business as the GPS system comes in proximity to the business. An icon corresponding to the mobile commerce platform 100 could be displayed adjacent to the brand. Upon being touched, the icon could communicate with the mobile commerce platform 100. The mobile commerce platform 100 could then initiate the opt-in process for a mobile campaign associated with the brand. For example, the mobile commerce platform 100, could prompt the subscriber to enter a mobile phone number into the GPS system. Once the subscriber supplies the mobile phone number and confirms the opt-in, the mobile commerce platform 100 could be configured to interface with the subscriber, as described in detail above. Furthermore, the mobile commerce platform 100, may be configured to transmit information to the subscriber anytime the GPS system comes into proximity with the business.

While particular embodiments and aspects of the present invention have been illustrated and described herein, various other changes and modifications can be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A mobile commerce platform comprising a visual design tool wherein:
the mobile commerce platform is electronically stored on a computing device and is configured to manipulate computer readable data electronically stored on the computing device;
the visual design tool comprises an interactive graphical canvas and a block diagram, such that the interactive graphical canvas is configured to enable the modification of the block diagram;
the block diagram comprises a first object block, a second object block and at least one connecting symbol;
the first object block defines a first campaign instance, the second object block defines a second campaign instance, and the at least one connecting symbol defines a campaign sequence; and
the mobile commerce platform is configured to execute a mobile campaign according to the first campaign instance, the second campaign instance and the campaign sequence.

2. The mobile commerce platform as claimed in claim 1 wherein the mobile campaign comprises one or more of sending and receiving data through a wireless network.

3. The mobile commerce platform as claimed in claim 2 wherein:
one or more of the first object block and the second object block comprise a property set;
the mobile commerce platform further comprises a behavioral engine; and
the behavioral engine is configured to access the property set and invoke a filter operation.

4. The mobile commerce platform as claimed in claim 3 wherein:
the property set comprises a category property comprising multiple desired event fields and configured to be accessed to set a selected group of the desired event fields;
at least one subscriber is associated with each of the desired event fields; and
the filter operation comprises eliminating subscribers from a campaign instance based on the at least one subscriber associated with the selected group.

5. The mobile commerce platform as claimed in claim 3 wherein:
the property set comprises a subscriber group property comprising multiple segments and configured to be accessed to set a selected group of the multiple segments;
the multiple segments are hierarchical and at least one subscriber is associated with each of the segments; and
the filter operation comprises eliminating subscribers from a campaign instance based on the at least one subscriber associated with the selected group.

6. The mobile commerce platform as claimed in claim 3 wherein:
the property set comprises an attribute property comprising multiple interaction fields and configured to be accessed to set a selected group of the interaction fields;
the interaction fields comprise a tracking statistic and each of the at least one subscriber is associated with each of the interaction fields and the tracking statistic;
the tracking statistic is based on the at least one subscriber's interaction with the mobile campaign;
the filter operation comprises eliminating subscribers from a campaign instance based on the tracking statistic associated with the selected group.

7. The mobile commerce platform as claimed in claim 2 wherein one or more of the first object block and the second object block is a start object, a join object, offer object, a survey object, or an event object.

8. The mobile commerce platform as claimed in claim 7 wherein the interactive graphical canvas further comprises one or more of a help object and a stop object.

9. The mobile commerce platform as claimed in claim 2 wherein:
one or more of the first object block and the second object block comprises a pattern scheduler, a trigger scheduler, and a range scheduler;
the pattern scheduler is configured to invoke a recurrence pattern operation for the transmission of a message through the wireless network in a repeating interval of time;
the trigger scheduler is configured to invoke a trigger operation for the transmission of the message through the wireless network at a set time or upon the occurrence of a pre-defined event; and
the range scheduler is configured to invoke a range operation for the transmission of the message through the wireless network throughout a time period.

10. The mobile commerce platform as claimed in claim 1 wherein:
the mobile commerce platform further comprises a graphics tool and a coupon code generator;
the graphics tool is configured to import graphics and promotional text generate a coupon design;
the coupon code generator is configured to generate a coupon code;
the mobile commerce platform is configured to generate a coupon message comprising the coupon design and the coupon code; and
the coupon message is configured to be displayed on a mobile device.

11. The mobile commerce platform as claimed in claim 2 wherein:
the mobile commerce platform is configured to receive a photo message through the wireless network;
the photo message comprises a photograph of a barcode configured to extract the barcode from the photo message and convert the barcode into a decoded data;
the barcode is a one dimensional barcode or two dimensional barcode;
the mobile commerce platform further comprises a barcode validator;
the decoded data is electronically stored on the computing device;
the mobile commerce platform is configured to transmit a decoded message to the mobile device through the wireless network; and
the decoded message comprises a URL that links to the decoded data.

12. The mobile commerce platform as claimed in claim 1 wherein the mobile commerce engine further comprises a pin generator, an encryption/decryption tool, an OCR tool, a billing/invoicing tool, a reporting tool and an analytics tool.

13. The mobile commerce platform as claimed in claim 2 wherein:
the mobile commerce platform is configured to receive a coupon code from a designated mobile device through the wireless network;
the coupon code is SMS; and
the mobile commerce engine is configured to validate the coupon code and transmit the validation to the designated mobile device through the wireless network.

14. A method for creating and managing the information flow of a mobile campaign comprising:
registering at least one subscriber mobile device into a mobile commerce platform, wherein the mobile commerce platform is electronically stored on a computing device and is configured to manipulate computer readable data electronically stored on the computing device;
providing an interactive graphical canvas, wherein the interactive graphical canvas is configured to invoke at least one operation of the mobile commerce platform;
providing a block diagram within the interactive graphical canvas, wherein the block diagram is configured to be altered and comprises a first object block, a second object block and at least one connecting symbol;
executing, in a sequence determined by the at least one connecting symbol, the at least one operation according to the first object block and the at least one operation according to the second object block.

15. The method of claim 14 further wherein one or more of the first object block and the second object block is a start object, a join object, offer object, a survey object, or an event object.

16. The method of claim 15 further comprising:
segmenting the at least one subscriber mobile device into at least one subscriber group;
associating actions of the at least one subscriber mobile device with at least one attribute;
storing electronically at least one preference of the at least one subscriber mobile device;
categorizing the at least one subscriber mobile device based on the at least one preference into at least one category;
measuring a statistic based on one or more of the at least one subscriber group, the at least one behavioral tendency, and the at least one category; and
invoking at least one operation based on the statistic.

17. The method of claim 14 further comprising:
transmitting an electronic signal that corresponds to a transaction that requires verification from the mobile commerce platform to an IVR system;
calling the at least one subscriber mobile device;
collecting a PIN from the at least one subscriber mobile device with the IVR system;
communicating electronically the PIN to the mobile commerce system;
verifying that the PIN matches an associated PIN, wherein the associated PIN is associated with the at least one subscriber mobile device and is electronically stored on a computing device;
creating a result that is affirmative or negative, wherein an affirmative result corresponds to a match between the PIN and the associated PIN, and a negative result corresponds to a mismatch between the PIN and the associated PIN; and
communicating the result to the at least one subscriber mobile device.

18. The method of claim 14 further comprising:
establishing a referral quota;
tracking a referral metric associated with the at least one subscriber mobile device, wherein the referral metric is based on the number of opt-in notifications associated with the at least one subscriber mobile device; and
rewarding an account associated with the at least one subscriber mobile device when the referral metric meets the referral quota.

19. The method of claim 14 further comprising:
organizing a transaction data associated with the at least one subscriber mobile device;
transmitting an encrypted portion of the transaction data through the wireless network;
converting the encrypted portion to a decrypted information that is configured to be displayed on the at least one mobile device, wherein the decrypted information is a barcode or an alphanumeric; and
erasing the decrypted information upon loss of the at least one subscriber mobile device.

20. The method of claim 14 wherein:
the mobile commerce platform is configured to interact with an icon on the at least one subscriber mobile device by executing an action associated with the icon; and
the subscriber mobile device is a GPS system.
